(19) United States
(12) Patent Application Publication
(10) Pub. No.: US 2007/0171582 A1
(43) Pub. Date: Jul. 26, 2007

(54) Power supply having a transient load

(75) Inventor: Amos Lin, Taipei (TW)

Correspondence Address: COOPER & DUNHAM, LLP, 1185 AVENUE OF THE AMERICAS, NEW YORK, NY, 10036, US

(73) Assignee: Sea Sonic Electronics Co., Ltd.

(21) Appl. No.: 11/396,482

(22) Filed: Apr. 3, 2006

(30) Foreign Application Priority Data
Jan. 23, 2006 (TW) 095102437

(51) Int. Cl. H02H 7/00

(52) U.S. Cl. 361/18

(57) ABSTRACT

A power supply has a transient load and a transformer with a primary side and a secondary side. The secondary side of the transformer includes multiple output voltage terminals. One of the output voltage terminals is coupled to the primary side to form a feedback configuration. The output voltage terminal coupled to the primary side is further coupled to the transient load. When the output voltage terminal outputs a voltage, the transient load consumes power only within a period of time and then stops consuming the power.

### BACKGROUND OF THE INVENTION

1. Field of the Invention

The invention relates to a power supply, and more particularly to a power supply having a transient load to ensure that an output of the power supply device can meet a minimum load requirement and also can avoid wasting power consumption.

2. Description of the Related Art

With reference to FIG. 10, a conventional power supply includes a single transformer 10 to provide multiple output voltages such as +3.3V, +5V and +12V. One of the output voltages +12V feedbacks to a primary side of the transformer 10 through a photo coupler 12 and a control IC (integrated circuit) 14.

With the conventional power supply, a minimum load requirement is defined in accordance with the specification of the transformer 10. The minimum load requirement has to be met especially when the transformer 10 is configured to have a single feedback path from one of multiple output voltages to the input side.

For a system, such as a personal computer, equipped with the power supply is activated, the output voltage +12V of the power supply has a period in which no power consumption occurs. Thus the transformer 10 does not comply with the minimum load requirement. Consequently, the other output voltages +3.3V and +5V of the power supply cannot be normally output and the system is unable to be activated. A typical method to overcome the aforesaid problem is to provide an additional dummy load to be connected to one output terminal of the output voltage +12V. However, the dummy load consumes power continually and further reduces efficiency of the power supply.

### SUMMARY OF THE INVENTION

The present invention provides a power supply with a transient load. The power supply uses the transient load to ensure that all output voltages can be normally supplied when the power supply is activated. The transient load does not consume the power all the time to achieve a much better working efficiency for the power supply.

To achieve the above objective, the power supply has a transient load and a transformer with a primary side and a secondary side. The secondary side of the transformer has multiple output voltage terminals. One of the output voltage terminals is coupled to the primary side to form a feedback connection. The output voltage terminal coupled to the primary side is further coupled to the transient load. When the output voltage terminal outputs a voltage, the transient load consumes power only within a period of time and then stops consuming the power.

### BRIEF DESCRIPTION OF THE DRAWINGS

FIG. 1 is a circuit diagram of a power supply of a first embodiment in accordance with the present invention.

FIG. 2 is a circuit diagram of a transient load of a first embodiment in accordance with the present invention.

FIG. 3 is a circuit diagram of a transient load of a second embodiment in accordance with the present invention.

FIG. 4 is a circuit diagram of a power supply of a second embodiment in accordance the present invention.

FIG. 5 is a circuit diagram of a transient load of a third embodiment in accordance with the present invention.

FIG. 6 is a diagram of output voltage waveforms of a conventional power supply.

FIG. 7 is a diagram of output voltage waveforms of the power supply with a transient load in accordance with the present invention.

FIG. 8 is a diagram of output voltage waveforms of the conventional power supply being connected to a system.

FIG. 9 is a diagram of output voltage waveforms of the power supply in accordance with the present invention being connected to a system.

FIG 10 is a circuit diagram of a conventional power supply device.

### DETAILED DESCRIPTION OF THE INVENTION

In view of the period without the power consumption of the output voltage +12V when a power supply is activated, the present invention provides a solution to solve the problem of the period. The present invention is to add a transient load to the output terminal to reduce unnecessary power consumption after the period. Furthermore, the power supply of the present invention will not reduce an efficiency of the power supply.

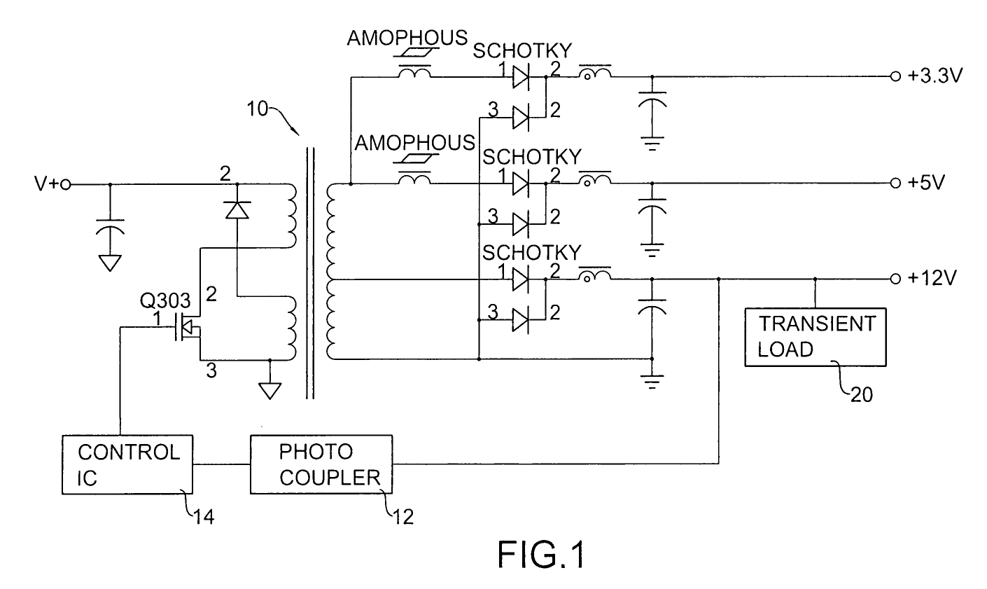

With reference to FIG. 1, a power supply includes a transformer 10, a photo coupler 12, a control IC (integrated circuit) 14 and a transient load 20. The transformer 10 provides multiple output voltages such as +3.3V, +5V and +12V. One output voltage +12V as a feedback terminal is connected to a primary side of the transformer 10 through the photo coupler 12 and the control IC 14. The output terminal of the output voltage +12V is coupled to the transient load 20.

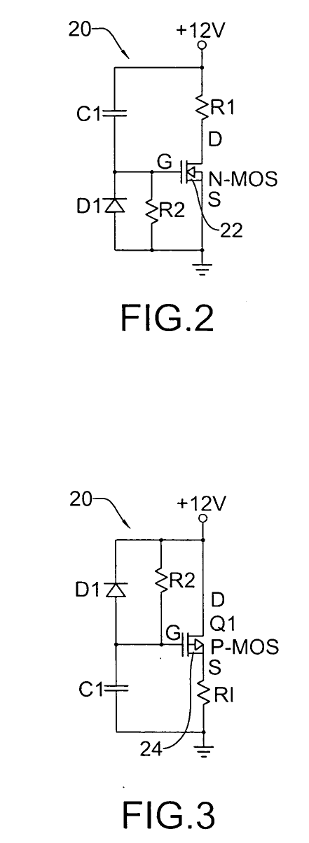

With reference to FIG. 2, a first embodiment of the transient load 20 includes a NMOS transistor 22 having a source, a drain and a gate. The source is coupled to the ground, the drain is coupled to the feedback terminal +12V through a power consumption resistor R1 and the gate is coupled to the ground through a charge resistor R2. The charge resistor R2 is connected to a diode D1 in parallel. A capacitor C1 is further coupled between the gate of the NMOS transistor 22 and the feedback terminal +12V.

The charge resistor R2 and the capacitor C1 form an RC recharge circuit. As soon as the power supply outputs the voltage +12V, a current flows through the capacitor C1 and the recharge resistor R2 to charge the capacitor C1. During charging operation, the current changes along with time. A high voltage generates on the charge resistor R2 to trigger the NMOS transistor 22 to be conducted. In a complete RC charging cycle, operating status of the NMOS transistor 22 is sequentially changed from the cut off region, the active region and the saturation region and then reversely from the saturation region, the active region returns to the cut off region.

When the NMOS transistor 22 is turned on, the current flows through the power consumption resistor R1. The resistor R1 consumes power. The power consumption of the resistor R1 is used to replace the conventional dummy load. Since the resistor R1 consumes the power only within the RC time constant, not consumes the power all the time, the power consumption at the output voltage terminal +12V can be minimized. Moreover, the system is ensured to be activated successfully.

With reference to FIG. 3, a second embodiment of the transient load 20 includes a PMOS transistor 24 having a source, a drain and a gate. The source is coupled to the ground through a power consumption resistor R1, the drain is coupled to the feedback terminal +12V and the gate is coupled to the feedback terminal +12V through a charge resistor R2. The charge resistor R2 is connected to a diode D1 in parallel. A capacitor C1 is coupled between the gate and the ground.

The charge resistor R2 and the capacitor C1 form an RC recharge circuit. As soon as the power supply outputs the voltage +12V, a current flows through the charge resistor R2 to charge the capacitor C1. During the charging operation, the current changes along with time. As the voltage of the capacitor increases, the PMOS transistor 24 is changed from the cut off region to the active region and eventually to the saturation region. When the PMOS transistor 24 is turned on, the current flows through the resistor R1 to cause power consumption. The power consumption of the resistor R1 replaces a conventional dummy load. Since the resistor R1 consumes the power only within the RC time constant, not consumes the power all the time, the power consumption at the output voltage terminal +12V can be minimized. Moreover, the system is ensured to be activated successfully.

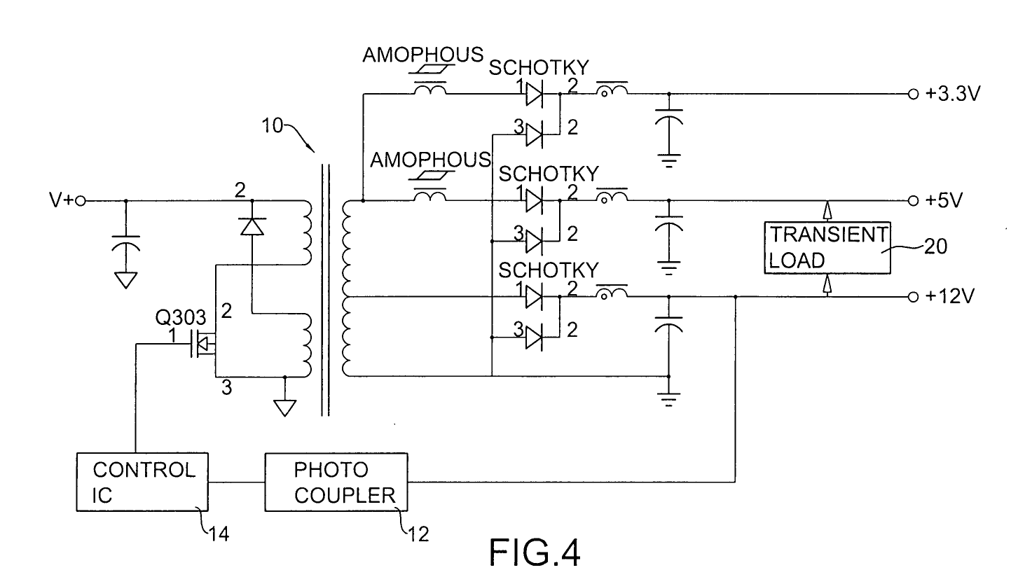

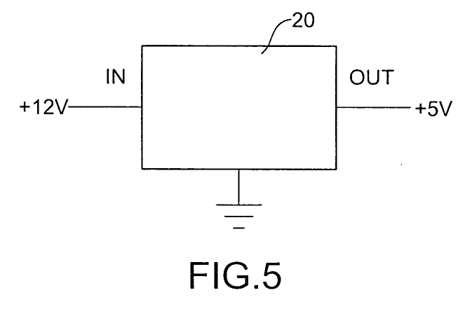

In the aforesaid example of the present invention, the transient load 20 is coupled between the feedback output voltage terminal +12V of the power supply device and the ground. Furthermore, the transient load 20 also can be connected between two output voltage terminals +12V and +5V of the power supply device as shown in FIG. 4. The transient load 20 is made up by a voltage regulator as shown in FIG. 5.

With reference to FIG. 5, the voltage regulator 20 has an input terminal to receive a +12V voltage and has an output terminal to output a +5V voltage. The input terminal of the voltage regulator 20 is coupled to the +12V output terminal of the power supply and the output terminal of the voltage regulator 20 is coupled to the +5V output terminal of the power supply.

When the +12V output terminal of the power supply burdens less than the minimum load requirement, the +5V output terminal of the power supply has insufficient output voltage. At this moment, the voltage regulator 20 outputs the voltage +5V to supplement the insufficient output voltage of the +5V output terminal of the power supply. Since the voltage regulator 20 acquires the input voltage from the +12V output terminal of the power supply and then provides to the +5V output terminal of the power supply, the voltage regulator 20 forms a transient load to the +12V output terminal for the power supply. Thereby the voltage regulator 20 satisfies the minimum load requirement of the +12V output terminal of the power supply to achieve a stability effect to the output voltages of the power supply.

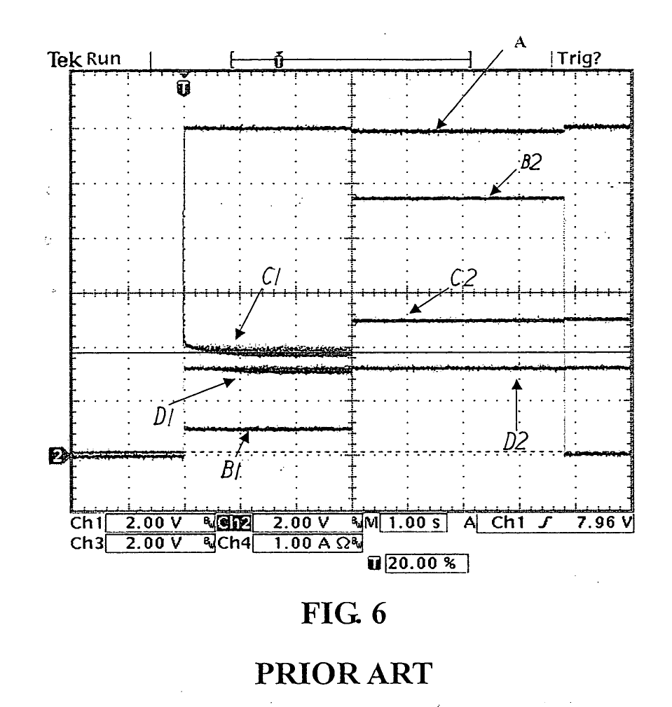

With reference to FIG. 6, an arrow A indicates a voltage waveform of the +12V output terminal of the conventional power supply, and arrows B1 and B2 collectively indicate a current waveform of the +12V output terminal of conventional the power supply. Arrows C1 and C2 collectively indicate a voltage waveform of the +5V output terminal of the conventional power supply and arrows D1 and D2 collectively indicate a voltage waveform of the +3.3V output terminal.

The +12V output terminal of the power supply burdens 0.5A while the minimum load requirement is 2A as shown in the B1 area. When the power supply starts, the +5V output terminal of the power supply only remains 3.6V as shown in the C1 area. Meanwhile, the +3.3V output terminal of the power supply is unstable with obvious ripples as shown in D1 area. When the +12V output terminal of the power supply burdens more than 2A of the minimum load requirement as shown in B2 area, the other output voltages turn to be normal as shown in the C2 and the D2 areas.

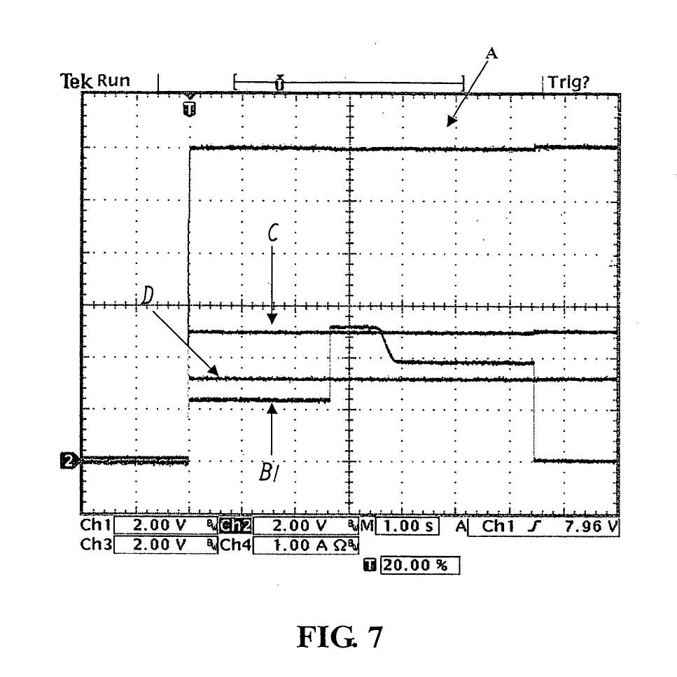

Contrary to FIG. 6, the +12V output terminal of the power supply shown in FIG. 7 burdens 0.5A but is further added with a transient load of 0.6A in accordance with the present invention. When the power supply starts, the +5V output terminal of the power supply burdens approximately 1.1 to 1.2A as shown in B1 area, so that the other two output voltages +5V and +3.3V can output the stable voltages as shown in waveforms C and D.

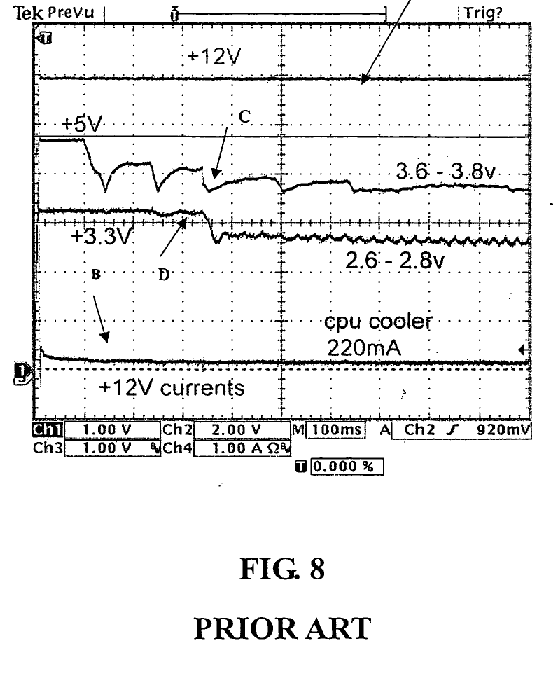

Moreover, with reference to FIG. 8, an output voltage waveform diagram is shown when the conventional power supply is coupled to a system. The load coupled to the +12V output terminal of the conventional power supply approximates to 220 mA far less than the minimum load requirement 2A. The 220 mA load as shown in a waveform B can be assumed as the power consumption of a CPU cooler. The +5V output terminal remains only 3.6 to 3.8V as a waveform indicated by an arrow C. The +3.3V output terminal remains only 2.6 to 2.8V as a waveform indicated by an arrow D. Under such an unstable status, the system can not operate normally and even activate a under-voltage protection to shut down the power supply.

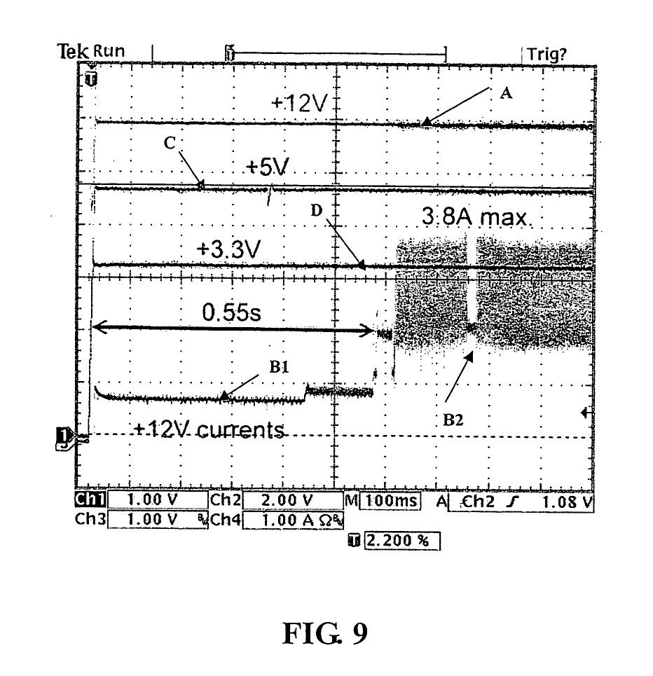

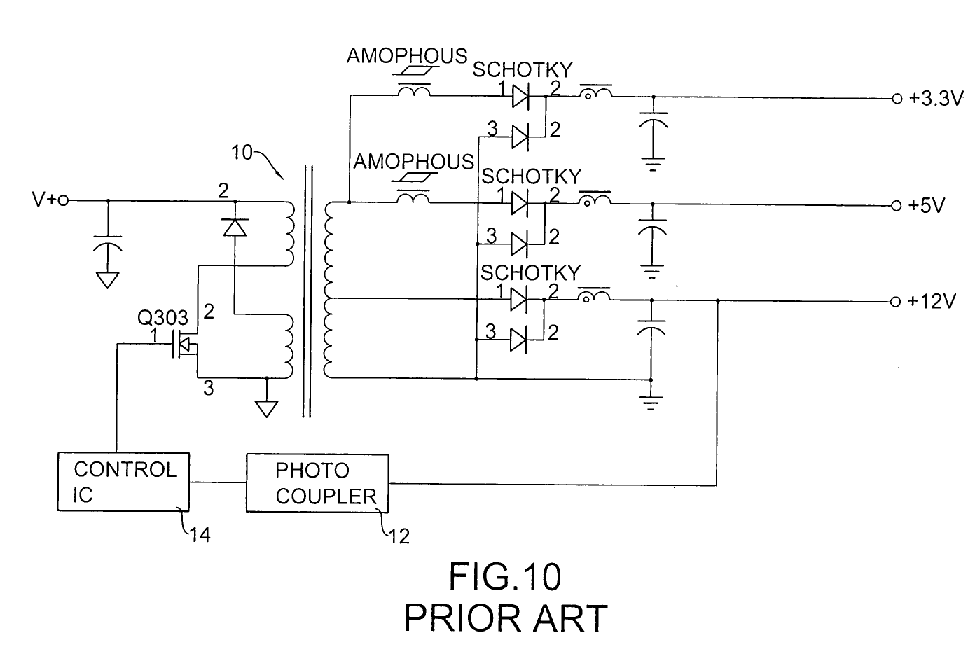

In comparison with FIG. 8, the +12V output terminal of the power supply shown in FIG. 9 is further added with a transient load of 0.6A. The system has a duration about 0.55 seconds indicated by B1 when the system is turned on. In this duration, the system does not operate normally yet. The +12V output terminal of the power supply replies on the added transient load of 0.6A to maintain a stable output, so that the other two output terminals of +5V and +3.3V shown in waveforms C and D can provide the voltages normally. After the 0.55 seconds duration, the +12V output terminal burdens a load of 3.8A. Thereby the system operates normally as shown in B2 area.

To sum up, the present invention provides the transient load to be coupled to the power supply that has a single feedback from multiple output voltages. Therefore the power supply can ensure to provide stable voltages when the power supply starts. Furthermore, the transient load does not consume the power all the time. The working efficiency for the power supply is better than the conventional power supply.

While the invention has been described by way of example and in terms of a preferred embodiment, it is to be understood-that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power supply having a transient load comprising:
a transformer with an primary side and a secondary side having multiple output voltage terminals, wherein one of the multiple output voltage terminal is coupled to the primary side; and
a transient load coupled to the output voltage terminal coupled to the primary side to temporarily consumes power only within a duration starting from the time at which the power supply initially produces a voltage at the output voltage terminal.

2. The power supply having a transient load as claimed in claim 1, wherein the transient load is coupled between the output voltage terminal and ground.

3. The power supply having a transient load as claimed in claim 2, the transient load comprising:
a NMOS transistor having a source coupled to the ground, a drain coupled to the output voltage terminal through a power consumption resistor and a gate coupled to the ground through a charge resistor; and
a capacitor coupled between the gate of the NMOS transistor and the output voltage terminal.

4. The power supply having a transient load as claimed in claim 2, the transient load comprising:
a PMOS transistor having a source coupled to the ground through a power consumption resistor, a drain coupled to the output voltage terminal and a gate coupled to the output voltage terminal through a charge resistor; and
a capacitor coupled between the gate of the PMOS transistor and the ground.

5. The power supply having a transient load as claimed in claim 3, wherein the charge resistor is further connected with a diode in parallel.

6. The power supply having a transient load as claimed in claim 4, wherein the charge resistor is connected with a diode in parallel.

7. The power supply having a transient load as claimed in claim 1, wherein the transient load is coupled between the output voltage terminal connected to the primary side and another one of the output voltage terminals.

8. The power supply having a transient load as claimed in claim 7, wherein the transient load is a voltage regulator.
